(19) United States
(12) Patent Application Publication
(10) Pub. No.: US 2006/0039764 A1
(43) Pub. Date: Feb. 23, 2006

(54) Drilling jig

(76) Inventor: George Moore, Queenland (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/537,865

(22) PCT Filed: Sep. 12, 2003
(86) PCT No.: PCT/AU03/01220

§ 371 Date: Jun. 7, 2005

(30) Foreign Application Priority Data
Jan. 8, 2003 (AU) 2003900081

(51) Int. Cl. B23B 35/00

(52) U.S. Cl. 408/1 R

(57) ABSTRACT

A drilling jig (1) adapted to be used with a drill press to guide a drill for drilling aligned holes in a workpiece, typically a piece of wood, wherein the jig includes: an attachment means (2) adapted to be releasably attached to a drill press table (40): a workpiece holder (3) pivotally connected to the attachment means and the workpiece holder is adapted to releasably hold a workpiece in position whereby the workpiece pivots relative to the attachment means to allow for angled drilling of the held workpiece.

### FIELD OF THE INVENTION

This invention is related to a drilling jig, in particular, but not limited to a doweling jig for locating holes to be drilled at any angle into a workpiece.

### BACKGROUND OF THE INVENTION

Drilling jigs for enabling holes to be drilled into wooden workpieces for the particular purposes, such as drilling matching holes for insertion of dowels, are known.

In the past when drilling two pieces of timber or other material to make a joint, typically a dowel joint, one piece could be drilled on a drill press, while the other piece that needed drilling in the end grain, would need to be marked out, placed on a bench, clamped down and drilled by hand. This process was very time consuming and inaccurate.

Clamping doweling jigs are also known, however these known jigs have a clamping face and drill guide which is immovable with respect to the clamping face and are not easy to use.

The prior art are mostly inaccurate and/or complicated to use as each workpiece has to be marked out, clamped to a bench and each piece is drilled after lining it up by eye.

The prior art are not easy to work with, require frequent set-ups, take time to set up and usually require a skilled user.

What is required is a drilling jig which overcomes the disadvantages of the known art and which is practical, economic and can be easily used by anyone, typically the unskilled home handyman.

### OBJECT OF THE INVENTION

It is an object of the invention is to provide an alternative drilling jig that seeks to ameliorate some of the disadvantages of the prior art or at least provide the public with a useful choice.

### SUMMARY OF THE INVENTION

In one aspect the invention resides in a drilling jig adapted to be used with a drill press to guide a drill for drilling aligned holes in a workpiece, typically a piece of wood, wherein the jig includes:

an attachment means adapted to be releasably attached to a drill press table;

a workpiece holder pivotally connected to the attachment means and the workpiece holder is adapted to releasably hold a workpiece in position whereby the workpiece holder pivots relative to the attachment means to allow for angled drilling of a held workpiece.

Preferably the attachment means includes a first horizontal planar member having at least one longitudinal extending slot for accommodating a first clamp to releasably attach the first horizontal planar member at different positions on the drill press table.

Preferably the attachment means includes a second horizontal planar member having at least one longitudinal extending slot for accommodating a second clamp to releasably attach the second horizontal planar member at different positions on the drill press table, and adjacent to the first horizontal planar member.

Preferably the clamps are adapted to extend through corresponding apertures in the drill press table.

Preferably each clamp includes a knob connected at one end of a threaded shaft and a clamping jaw at the other end of the shaft.

Preferably the workpiece holder is pivotally connected to a side edge of the first horizontal planar members and depends downwardly from that first horizontal planar member.

Preferably the workpiece holder is pivotally connected to the first horizontal planar member by an adjustable pivot pin that allows the workpiece holder to pivot freely relative to the horizontal planar member when the pivot pin is untightened and that allows the workpiece holder to be held in position at a desired angle relative to the horizontal planar member when the pivot pin is tightened.

Preferably the first horizontal planar member is adapted to slide relative to the second horizontal planar member when a respective clamp is released and that the second horizontal planar member has indicia on a top edge surface of the second horizontal planar member and the first horizontal planar member has a pointer means on a top edge surface of the first horizontal planar members surface so that the position of the first horizontal planar member relative to the second horizontal planar member can be recorded.

Preferably the indicia is a linear measurement, typically that of a ruler and the pointer means on the first horizontal planar member is a triangle shaped pointer having one end of the triangle points toward the linear measurement on the second horizontal planar member such that first horizontal planar member and the workpiece can be set at a desired linear position on the drill press table.

Preferably the adjustably pivot pin is tightened by a fastening means, typically a spanner.

Preferably the first horizontal planar member has an aperture preferably a longitudinal extending slot, adapted to allow the adjustable pivot pin to be tightened or untightened by the fastening means.

Preferably the workpiece holder includes a workpiece clamp to hold the workpiece in position and also includes an adjustable stopper means adapted to allow a bottom portion of the workpiece to rest on the stopper means.

Preferably the workpiece clamp, in the clamping position, holds the workpiece against a surface of the horizontal planar member.

Preferably the workpiece holder includes a longitudinal planar member having the workpiece clamp in a fixed position thereon and fixing means connectable to the stopper means to allow the position of the stopper means to be adjusted.

Preferably the workpiece holder includes holes spaced apart along the longitudinal length of the workpiece such that fixing means can be inserted in a respective hole to hold the stopper means at a desired position on the length of the workpiece holder.

Preferably the workpiece holder has a longitudinal slot in which the fixing means can be inserted to hold the stopper means at the desired position on the length of the workpiece holder.

Preferably the stopper means includes a stop positioned on one side of the workpiece holder and the fixing means includes a knob positioned on the other side of the workpiece holder and includes a shaft threadably connected at one end to the knob wherein the shaft is adapted to pass through the holes or slot in the workpiece so that the stop can be releasably be held in position by adjusting the knob.

Preferably the fixing means is an elongate portion, typically made of metal, and the elongate portion is adapted to slide in a channel in the workpiece holder to allow the stop move up and down the length of the workpiece holder.

Preferably the workpiece holder includes holes spaced apart along the longitudinal length of the workpiece such that a stop holder means can be inserted into a hole to press the elongate member forcibly against the inside walls of the mouth of the channel to prevent the elongate member and the stopper means from sliding.

Preferably the attachment means includes an angular adjustment means whereby the angle of the workpiece holder relative to the attachment means can be adjusted.

Preferably the angular adjustment means is a protractor having an arcuate slot, through which a protractor clamping means can pass so that the workpiece holder can be set at a desired angle.

Preferably the protractor clamping means includes a threaded bolt and wing nut or knurled knob arrangement whereby the threaded bolt is adapted to be fixed to the workpiece holder and is adapted to pass through and move within the arcuate slot and the wingnut or knurled knob can be fastened to the threaded bolt to allow the workpiece holder to be set at the desired angle when the protractor clamping means is tightened.

Preferably the protractor clamping means includes a threaded bolt and wingnut or knurled knob arrangement whereby the wingnut or knurled knob is integral with the threaded bolt and whereby the threaded bolt can pass through the arcuate slot and into a corresponding threaded hole in the workpiece so as to allow the workpiece to be set at a desired angle when the protractor clamping means is tightened.

Preferably the workpiece holder, with respect to the horizontal plane of the first horizontal member can be rotated to 360°, typically the workpiece holder rotates between 0° and 180° so that holes can be drilled in a workpiece that are either parallel or transverse with the longitudinal axis and any angle therebetween.

Preferably a workpiece held in the drilling jig is able to be worked on vertically, horizontally or any angle therebetween.

In a further aspect the invention resides in a method of using a drilling jig as hereinabove described including the steps of:

placing the first horizontal planar member to a drill press table;

aligning the longitudinal extending slot with a corresponding opening in the drill press table;

inserting a shaft of a clamping member into the slot and opening and attaching a clamping portion to one end of the shaft and a knob to the other end;

aligning the first horizontal planar member to a desired position on the drill table by sliding the first horizontal member with respect to the table and then tightening the knob of the clamping member to firmly hold the first horizontal planar member to the drill press table;

selecting the desired angle to which holes are to be drilled into a workpiece by rotating the workpiece holder about the pivot pin until the desired angle is obtained;

tightening the pivot pin with fastening means to hold the workpiece at the desired angle;

selecting and positioning a workpiece on the workpice holder so that the end to be drilled is flush with the top surface of workpiece holder;

clamping the workpiece to the workpiece holder, and sliding and retaining the stopper means such that the stopper means abuts the end of the workpiece opposite to the end being drilled.

Preferably the method includes the further steps of:

attaching a second horizontal planar member to the drill press table in a similar fashion to the first horizontal planar member such that the two horizontal planar members are positioned, each other in a side by side adjacent relationship and are able to slide relative to another;

positioning the first horizontal planar member in a desired position using the pointer on the horizontal planar member and the ruler markings on the second horizontal planar member;

tightening the respective clamping members of each horizontal planar member.

### BRIEF DESCRIPTION OF DRAWINGS

Embodiments of the invention will now be described by way of example only, with reference to the accompanying drawings of which:

FIG. 1 is a side view of a drilling jig in accordance to an embodiment of the invention.

FIG. 2 is a plan view of the drilling jig shown in FIG. 1 positioned on a drill press table.

FIG. 3 is a front view of a drilling jig shown in FIG. 1 with workpiece at an angle.

FIG. 4 is a back view of a drilling jig shown in FIG. 1.

FIG. 5 is a perspective view of the workpiece holder showing the sliding stop in accordance to the embodiment of the invention shown in FIG. 1.

FIG. 6 is a perspective view of a part of a drilling jig in accordance to a further embodiment of the invention.

### DESCRIPTION OF THE INVENTION

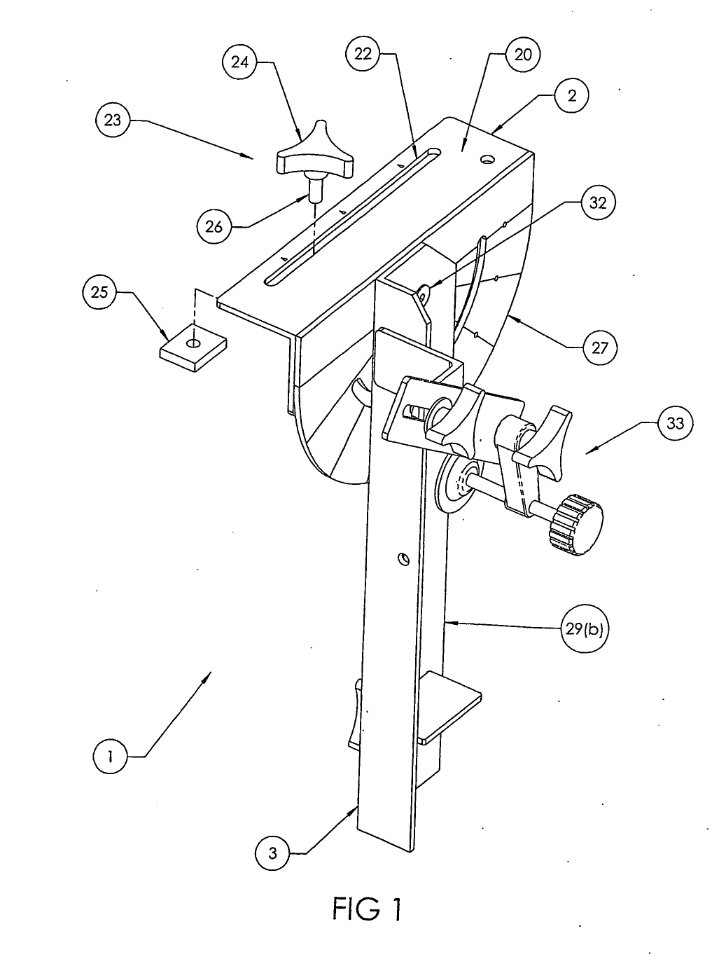

Referring to FIG. 1, the drilling jig 1 includes two major portions, these being a drillpress table attachment means 2 and a workpiece holder 3. The workpiece holder 3 is pivotably fixed by an adjustable pivot pin 32 to the attachment means 2 so that a side edge 29(b) of the workpiece holder 3 is able to be moved at different angles relative to the attachment means 2. The workpiece holder 3 depends downwardly from the attachment means 2 such that when the longitudinal plane of the workpiece 3 is perpendicular with horizontal plane of attachment means 2, the top surface of the workpiece holder 3 is flush with the top surface of the attachment means 2 (as shown in FIG. 1).

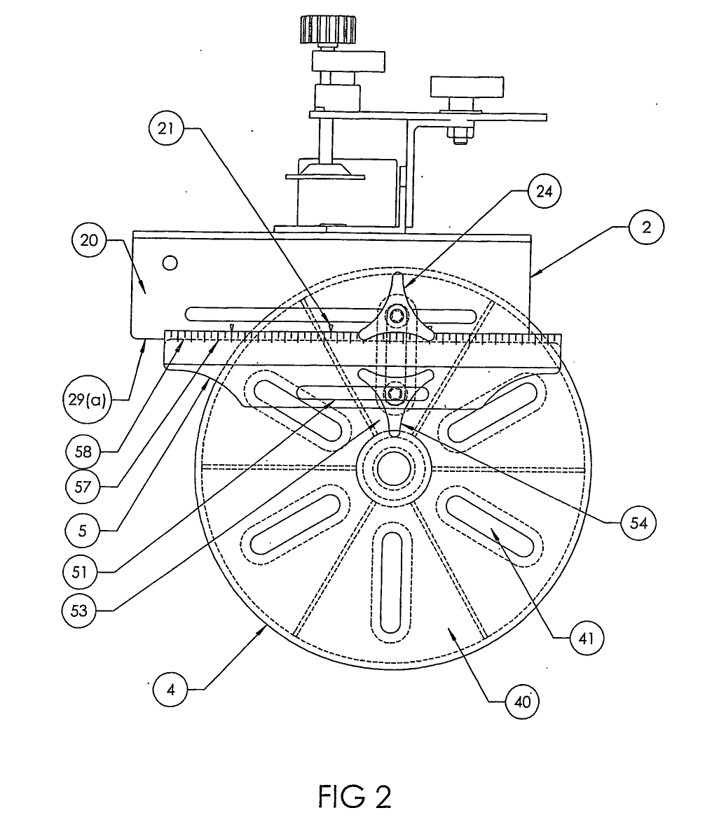

The attachment means 2 includes a horizontal planar member 20, typically made from wood. The horizontal planar member 2 has two longitudinal slots 22, 28 extending there through. Longitudinal slot 20 is adapted to accommodate a clamping member 23 for clamping the horizontal planar member 20 to an upper surface 40 of a drill press table 4 (FIG. 2).

Turning to FIGS. 1 and 2, typically the clamping member 23 has a threaded shaft 26 connected at one end to a clamping portion 25 and at the other end is releasably connected to a knob portion 24 so that in use, the shaft 26 passes through slot 22 and through a corresponding aperture 41 in the drill press table 4 so that in a clamped state, the clamping portion 25 abuts the under surface of the drill press table and the knob portion abuts the top portion of the horizontal planar member 2. The longitudinal slot 22 allows the horizontal planar portion 2 to be moved sideways with respect to the drill press table 4 when the knob portion 24 is loosened so that horizontal planar portion 20 and thus the workpiece holder 3 can be set at a desired position on the drill press table 4.

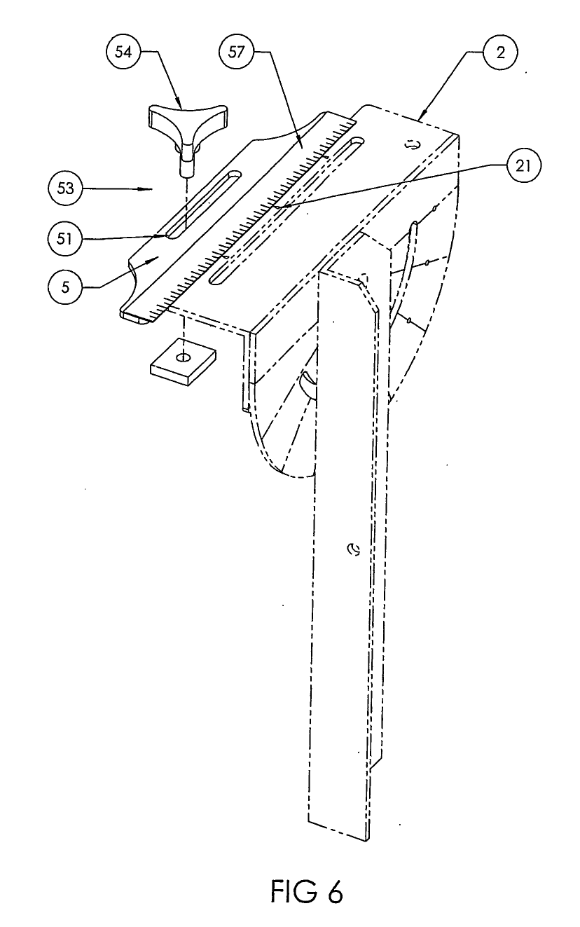

Referring to FIGS. 2 and 6, the attachment means 2 can include a further horizontal planar member 5 with a longitudinal slot 51 for accommodating a clamping member 53 (similar in type to the clamping member 23). The further horizontal planar member 5 is attached and secured to the drill press table 4 in similar fashion to horizontal planar member 2 so that two side edges 291(a), 58 of the two horizontal planar members are positioned in close proximity adjacent each other. The horizontal planar member 5 has ruler markings 57 on its top surface adjacent a side edge 58. In use the two horizontal planar members can slide relative to one another by loosening one of the knobs 24, 54 of either clamping member, preferably knob 24, so that, in combination with a pointer 21 on the top surface and adjacent a side edge 29(a) of the horizontal planar members 2, the exact distance the horizontal planar member 2 slides with respect to the other horizontal planar member 5 and hence the drill press table 4 can be noted and/or selected.

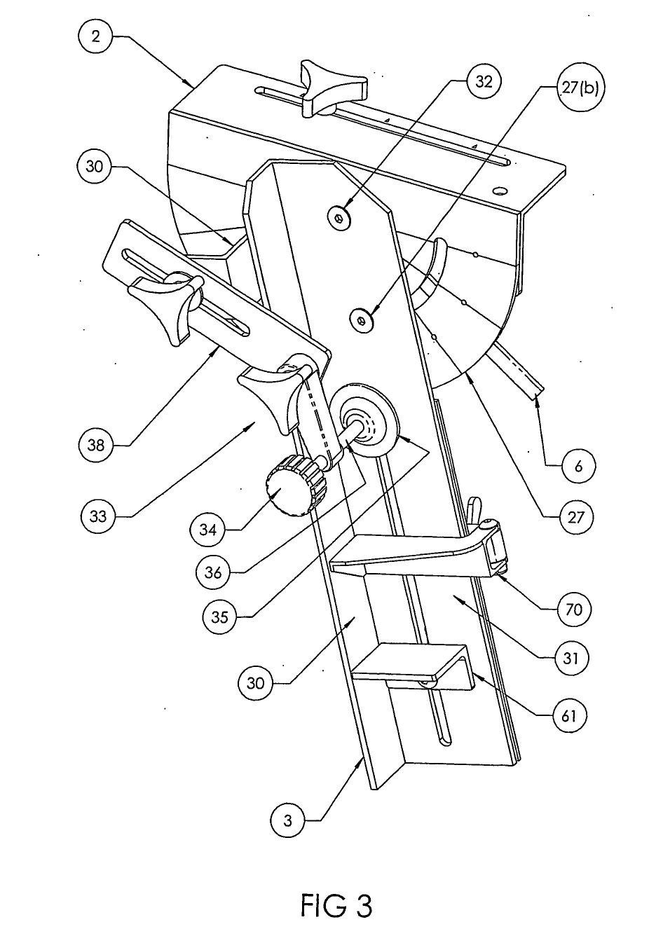

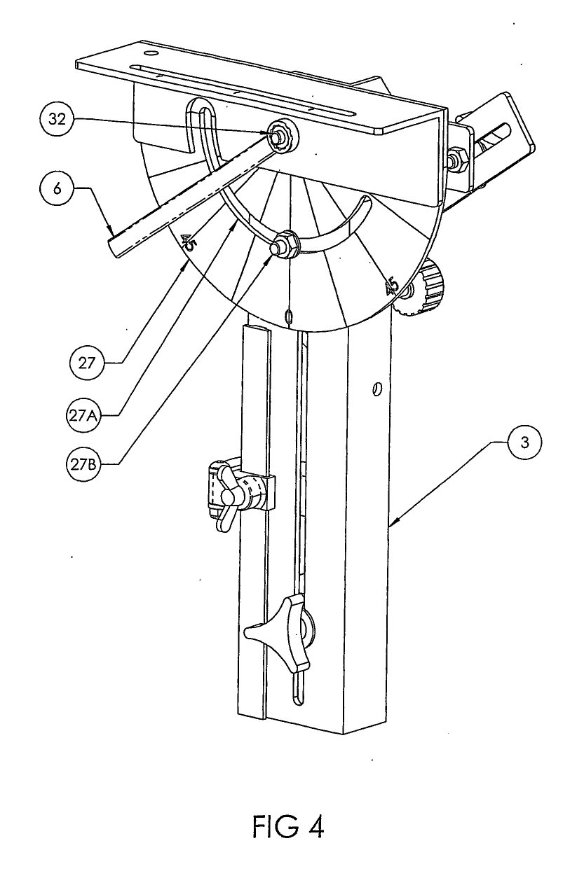

The other longitudinal slot 28 in the horizontal planar member 20 is adapted to provide access to the adjustable pivot pin 32 by a spanner 6 or similar tool, so as to allow for the pivot pin to be tightened or loosened. In the loosened condition the pivot pin 32 allows for the workpiece holder 3 to pivot relative in an angular direction A (FIG. 3 and FIG. 4) to the horizontal planar member 2 and in the tightened condition the workpiece is able to be held in a desired position (as shown in FIG. 3).

Referring to FIGS. 1, 3 and 4, the drilling jig 1 can include an angular adjustment means, typically a protractor 27 positioned between the workpiece holder 3 and side edge 29(b) of horizontal planar member 2 so that in use the workpiece holder 3 can be set at a particular angle relative to the horizontal planar member 2 to allow holes to be drilled into a workpiece at desired angles.

As shown in FIG. 4, the protractor can have an arcuate slot 27(a) through which a protractor clamp 27(b) can pass through to the workpiece holder 3. The protractor clamp 27(b) can include a threaded bolt fixed to the workpiece holder 3 and is adapted to pass through and move within the arcuate slot 27(a). The free end of the bolt is threadably connected to a wing nut or knurled knob so when the pivot pin 32 is in a loosened condition and the wing nut or knurled knob is undone; the workpiece holder 3 is able to pivot to cause the bolt to move within the arcuate slot 27(a) until the bolt is aligned with a respective radial marking on the protractor indicating a particular angle after which the wing nut or knurled knob and pivot pin 32 of the protractor clamp 27(b) can be tightened to hold the workpiece at the desired angle.

Referring to FIGS. 1 and 3 the workpiece holder 3 will now be described. The workpiece holder 3 is adapted to hold any suitable length of workpiece, typically a piece of timber to be drilled. The workpiece holder 3 is adapted so that a workpiece held therein can present a face to be drilled at any angle, therefore allowing for vertical or angled holes to be precisely drilled into the workpiece. In order to firmly hold a workpiece in position to be drilled, the workpiece holder 3 includes a clamping and stop arrangement. The clamping and stop arrangement includes a workpiece clamp 33.

The workpiece holder 3 has a workpiece abutting portion 31 and a side portion 30. The workpiece abutting portion 31 is attached at an upper portion via pivot pin 32 to the horizontal planar member 2.

Preferably the-workpiece clamp 33 is connected via clamp holder 38 to a side portion 30 of the workpiece holder 3 and is preferably positioned in a region immediately below the adjustable pivot pin 32.

The workpiece clamp 33 has a knob 34 connected to one end of a shaft 36 and has a workpiece engaging portion 35 connected to the other end of the shaft 36 such that as the clamp is tightened by turning the knob 34 the workpiece engaging portion moves toward the workpiece abutting portion 31 to allow, when in use, a workpiece to be clamped to the workpiece holder 3.

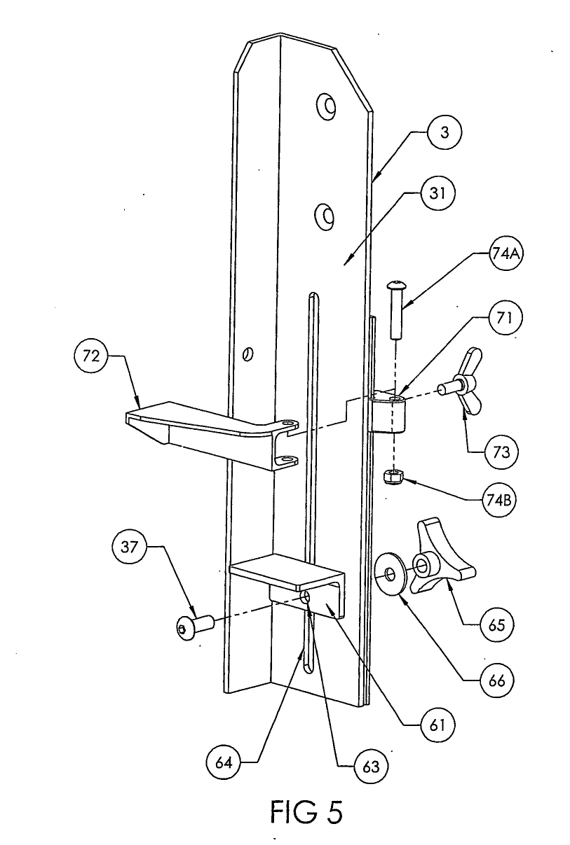

An adjustable stop 61 assists in holding a workpiece on the workpiece holder 3 and allows for workpieces of different sizes to be held in the workpiece holder 3. The adjustable stop 61 is able to be positioned at different heights on the workpiece abutting portion 31 In one preferred embodiment (as shown in FIG. 5) the adjustable stop 61 is connected to an elongate member 65, typically made from metal. The elongate member 65 is adapted to, slide in channel 62 in the workpiece abutting portion 31 and allows the stop 61 to slide up and down the length of workpiece abutting portion 31. The workpiece abutting portion 31 has holes 63, 64 (also shown in FIG. 4) along its length which open into the channel 62. The holes 63, 64 are adapted to accommodate a stopholder 37 having a knob and a shaft sized to fit into the holes 63, 64 so that when the stopholder 37 is inserted into a hole an end of the shaft presses against the elongate member 65 to forcibly push the elongate member against the inside walls of the channel 62 to prevent the elongate member 65 and stop 61 from sliding. The holes can be threaded so as to cooperate with a corresponding threaded shaft of the stop holder 37.

In another form (not shown) the adjustable stop 61 is threadably connected to the shaft of the stop holder 37 passing through a hole 63, 64 in the workpiece abutting portion 31 so that as the stop holder 37 is tightened the stop 61 is drawn toward the workpiece abutting portion 31 to prevent the stop 61 from sliding. In this arrangement the holes could be replaced by a longitudinally extending slot which is dimensioned to accommodate the shaft of the stop holder 37.

In use, the drilling jig is attached to a drill press table 4 by placing the horizontal planar member 2 on the drill press table 4 and aligning the longitudinal extending slot 22 with a corresponding opening 41 on the drill press table 4. The shaft 26 of the clamping member 23 is inserted into both slots and the clamping portion 25 is then attached to the free end of the shaft 26. The knob 24 of the clamping member is wound to clamp the horizontal planar member 20 to the drill press table 4. Due to the nature of the elongated slot 22 the horizontal planar member 2 can slide relative to drill press table 4 so as to allow for the horizontal planar member 2 to set to a desired position on the drill press table 4. This can be achieved by loosening the clamping member 23 slightly and then sliding the horizontal planar member 20. To assist a correct position being obtained a further horizontal planar member 5 (as shown in FIG. 2) with ruler markings 57 can be attached to the drill press table in similar fashion to horizontal planar member 2. The further horizontal planar member 5 is fixed in place on the drill press table 4 and the horizontal planar member 2 is able to slide relative to the further horizontal planar member 5 and using the ruler markings 57 and pointer 21 on the horizontal planar member 2 an accurate position on the drill press table 4 can be selected.

Once the drilling jig is firmly fixed to the drill press table 4 the workpiece holder 3 can be set at the desired angle to which holes are to be drilled into a workpiece. The pivot pin 32 is loosened by spanner 6 and the protractor clamp 27(b) is untightened, then the workpiece holder 3 is moved to a desired angle, set by using the markings on the protractor 27. At the desired angle the protractor clamp 27(b) is tightened and the pivot pin 32 is tightened by spanner 6. A workpiece is then selected and placed in the workpiece holder 3 so that the end of the workpiece to be drilled is flush with the top edge the workpiece abutting portion 31. The stop 61 is slid into contact with the end opposite the end to be drilled workpiece and stopholder adjusted to hold the stop 61 in place. The workpiece clamp 33 is tightened so that the workpiece engaging portion 35 firmly holds the workpiece in place whilst the holes are being drilled.

The drilling jig allows for a workpiece held therein to be worked on and used vertically, horizontally or any angle therebetween.

Where in the foregoing description reference has been made to integers or components known equivalents, then such equivalents are deemed to be incorporated herein as if individually set forth.

Throughout the description of this specification the word “comprise” and variations of that word such as “comprises” and “comprising”, are not intended to exclude other additives, components, integers or steps.

It is to be understood that the scope of the invention is not limited to the described embodiments and therefore that numerous variations and modifications may be made to these embodiments without departing from the scope of the invention.

1. A drilling jig adapted to be used with a drill press to guide a drill for drilling aligned holes in a workpiece, typically a piece of wood, wherein the jig includes:
an attachment means adapted to be releasably attached to a drill press table;
a workpiece holder pivotally connected to the attachment means and the workpiece holder is adapted to releasably hold a workpiece in position whereby the workpiece pivots relative to the attachment means to allow for angled drilling of the held workpiece.

2. A drilling jig as claimed in claim 1 wherein the attachment means includes a first horizontal planar member having at least one longitudinal extending slot for accommodating a first clamp to releasably attach the first horizontal planar member at different positions on the drill press table.

3. A drilling jig as claimed in claim 2 wherein the attachment means includes a second horizontal planar member having at least one longitudinal extending slot for accommodating a second clamp to releasably attach the second horizontal planar member at different positions on the drill press table, and adjacent to the first horizontal planar member.

4. A drilling jig as claimed in claim 3 wherein the clamps are adapted to extend through corresponding apertures in the drill press table.

5. A drilling jig as claimed in claim 3 wherein each clamp includes a knob connected at one end of a threaded shaft and a clamping jaw at the other end of the shaft.

6. A drilling jig as claimed in claim 2 wherein the workpiece holder is pivotally connected to a side edge of the first horizontal planar members and depends downwardly from that first horizontal planar member.

7. A drilling jig as claimed in claim 2 wherein the workpiece holder is pivotally connected to the first horizontal planar member by an adjustable pivot pin that allows the workpiece holder to pivot freely relative to the horizontal planar member when the pivot pin is untightened and that allows the workpiece holder to be held in the position at a desired angle relative to the horizontal planar member when the pivot pin is tightened.

8. A drilling jig as claimed in claim 3 wherein the first horizontal planar member is adapted to slide relative to the second horizontal planar member when a respective clamp is released and that the second horizontal planar member has indicia on a top edge surface of the second horizontal planar member and the first horizontal planar member has a pointer means on a atop edge surface of the first horizontal planar members surface so that the position of the first horizontal planar member relative to the second horizontal planar member can be recorded.

9. A drilling jig as claimed in claim 8 wherein the indicia is a linear measurement, typically that of a ruler and the pointer means on the first horizontal planar member is a triangle shaped pointer having one end of the triangle points toward the linear measurement on the second horizontal planar member such that first horizontal planar member and the workpiece can be set at a desired linear position on the drill press table.

10. A drilling jig as claimed in claim 7 wherein the adjustable pivot pin is tightened by a fastening means, typically a spanner.

11. A drilling jig as claimed in claim 10 wherein the first horizontal planar member has an aperture preferably a longitudinal extending slot, adapted to allow the adjustable pivot pin to be tightened by the fastening means.

12. A drilling jig as claimed in claim 1 wherein the workpiece holder includes a workpiece clamp to hold the workpiece in position and also includes an adjustable stopper means adapted to allow a bottom portion of the workpiece to rest on the stopper means.

13. A drilling jig as claimed in claim 12 wherein the workpiece clamp, in the clamping position, holds the workpiece against a surface of the horizontal planar member.

14. A drilling jig as claimed in claim 12 wherein the workpiece holder includes a longitudinal planar member having the workpiece clamp in a fixed position thereon and fixing means connectable to the stopper means to allow the position of the stopper means to be adjusted.

15. A drilling jig as claimed in claim 12 wherein the workpiece holder includes holes spaced apart along the longitudinal length of the workpiece such that fixing means can be inserted in a respective hole to hold the stopper means at a desired position on the length of the workpiece holder.

16. A drilling jig as claimed in claim 12 wherein the workpiece holder has a longitudinal slot in which the fixing means can be inserted to hold the stopper means at the desired position on the length of the workpiece holder.

17. A drilling jig as claimed in claim 14 wherein the stopper means includes a stop positioned on one side of the workpiece holder and the fixing means includes a knob positioned on the other side of the workpiece holder and includes a shaft threadably connected at one end of the knob wherein the shaft is adapted to pass through the holes or slot in the workpiece so that the stop can be releasably be held in position by adjusting the knob.

18. A drilling jig claimed in claim 14 wherein the fixing means is an elongate portion, typically made of metal, and the elongate portion is adapted to slide in a channel in the workpiece holder to allow the stop move up and down the length of the workpiece holder.

19. A drilling jig as claimed in claim 18 wherein the workpiece holder includes holes spaced apart along the longitudinal length of the workpiece such that a stop holder means can be inserted into a hole to press the elongate member forcibly against the inside walls of the mouth of the channel to prevent the elongate member and the stopper means from sliding.

20. A drilling jig as claimed in claim 1 wherein the attachment means includes an angular adjustment means whereby the angle of the workpiece holder relative to the attachment means can be adjusted.

21. A drilling jig as claimed in claim 20 wherein the angular adjustment means is a protractor having an arcuate slot, through which a protractor clamping means can pass so that the workpiece holder can be set at a desired angle.

22. A drilling jig as claimed in claim 21 wherein the protractor clamping means includes a threaded bolt and wing nut or knurled knob arrangement whereby the threaded bolt is adapted to be fixed to the workpiece holder and is adapted to pass through and move within the arcuate slot and the wingnut or knurled knob can be fastened to the threaded bolt to allow the workpiece holder to be set at the desired angle when the protractor clamping means is tightened.

23. A drilling jig as claimed in claim 21 wherein the protractor clamping means includes a threaded bolt and wingnut or knurled knob is integral with the threaded bolt and whereby the threaded bolt can pass through the arcuate slot and into a corresponding threaded hole in the workpiece so as to allow the workpiece to be set at a desired angle when the protractor clamping means is tightened.

24. A drilling jig as claimed in claim 2 wherein the workpiece holder, with respect to the horizontal plane of the first horizontal member can be rotated to 360°, typically the workpiece holder rotates between 0° and 180° so that holes can be drilled in a workpiece that are either parallel or transverse with the longitudinal axis and any angle therebetween.

25. A drilling jig as claimed in claim 1 wherein a workpiece held in the drilling jig is able to be worked on vertically, horizontally or any angle therebetween.

26. A method of using a drilling jig including the steps of:
placing a first horizontal planar member on a drill press table;
aligning a longitudinal extending slot on the first horizontal planar member with a corresponding opening in the drill press table;
inserting a shaft of a clamping member into the slot and opening and attaching a clamping portion to one end of the shaft and a knob to the other end;
aligning the first horizontal planar member to a desired position on the drill table by sliding the first horizontal member with respect to the table and then tightening knob of the clamping member to firmly hold the first horizontal planar member to the drill press table;
selecting the desired angle to which holes are to be drilled into a workpiece by rotating the workpiece holder about a pivot pin until the desired angle is obtained;
tightening the pivot pin with a fastener to hold the workpiece at desired angle;
selecting and positioning a workpiece on the workpiece holder so that the end to be drilled is flush with the top surface of workpiece holder;
clamping the workpiece to the workpiece holder, and sliding and retaining a stopper such that the stopper abuts the end of the workpiece opposite to the end being drilled.

27. The method of claim 26 wherein the method includes the further steps of:
attaching a second horizontal planar member to the drill press table in a similar fashion to the first horizontal planar member such that the two horizontal planar members are positioned, each other in a side by side adjacent relationship and are able to slide relative to another;
positioning the first horizontal planar member in a desired position using a pointer on the horizontal planar member and ruler markings on the second horizontal planar member;
tightening the respective clamping members of each horizontal planar member.

28. (Cancelled).

29. (Cancelled).
